(19) United States
(12) Patent Application Publication
(10) Pub. No.: US 2014/0354489 A1
(43) Pub. Date: Dec. 4, 2014

(54) ELECTRONIC APPARATUS

(71) Applicant: Kabushiki Kaisha Toshiba, Tokyo (JP)

(72) Inventor: Ippei Kashiwagi, Ome-shi (JP)

(73) Assignee: Kabushiki Kaisha Toshiba, Tokyo (JP)

(21) Appl. No.: 14/094,555

(22) Filed: Dec. 2, 2013

(30) Foreign Application Priority Data
May 31, 2013 (JP) 2013-115849

(51) Int. Cl. H01Q 1/24

(52) U.S. Cl. CPC H01Q 1/243
USPC 343/702

(57) ABSTRACT

According to an embodiment, an electronic apparatus comprises a first electrode configured to detect biometric information, and a first antenna. The first electrode and the first antenna are along an edge of a housing of the electronic apparatus. A feeding point of the first antenna is closer to the first electrode than to a center of the first antenna in a longitudinal direction.

### CROSS-REFERENCE TO RELATED APPLICATIONS

This application is based upon and claims the benefit of priority from Japanese Patent Application No. 2013-115849, filed May 31, 2013, the entire contents of which are incorporated herein by reference.

### FIELD

Embodiments described herein relate generally to an electronic apparatus capable of wireless communication.

### BACKGROUND

Recently, a structure in which an electronic apparatus such as a mobile terminal is equipped with a function of measuring biometric information has been known as conventional art. The electronic apparatus is equipped with an electrode for detecting the biometric information. The electronic apparatus inputs a signal indicating the biometric information via the electrode if a user touches the electrode.

If the electronic apparatus is equipped with a wireless communication function, an antenna is mounted on a housing. The electrode for detecting the biometric information has an influence on performance of wireless communication by the antenna. Thus, if the electrode is provided on the electronic apparatus, a position where the antenna is mounted is restricted. Especially, in a portable electronic apparatus, because a housing is small, it is difficult to mount the antenna in such a manner as to prevent an influence of the electrode.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an outer appearance of an electronic apparatus according to an embodiment.

FIG. 2 is a plan view showing a back surface of a tablet computer according to the embodiment.

FIG. 3 shows an interior of a housing seen from a back surface side of the tablet computer according to the embodiment.

FIG. 4 shows an example of a side sectional view according to the embodiment.

FIG. 5 shows an example of a side sectional view according to the embodiment.

FIG. 6 is a diagram for explanation of arrangement relationship of antennas according to the embodiment.

FIG. 7 shows a system configuration of the tablet computer according to the embodiment.

### DETAILED DESCRIPTION

Embodiments will be hereinafter described with reference to the accompanying drawings.

According to an embodiment, an electronic apparatus includes a first electrode configured to detect biometric information; and a first antenna. The first electrode and the first antenna are along an edge of a housing of the electronic apparatus. A feeding point of the first antenna is closer to the first electrode than to a center of the first antenna in a longitudinal direction.

FIG. 1 shows an outer appearance of an electronic apparatus according to an embodiment. The electronic apparatus is, for example, portable and has a wireless communication function. Furthermore, the electronic apparatus of the embodiment has a function of measuring biometric information usable to judge a health condition of a human body.

The electronic apparatus can be implemented as, for example, a tablet computer, a notebook-sized personal computer, a smartphone, a PDA (personal digital assistant), a portable game machine, etc. Hereinafter, an example of the electronic apparatus implemented as a tablet computer 10 will be described. FIG. 1 shows an example of a state in which the tablet computer 10 is held by both hands 16 of a user.

The tablet computer 10 is a portable electronic apparatus called a tablet or slate computer. As shown in FIG. 1, in the tablet computer 10, a touch screen display 14 is arranged in a center of a front surface of a housing 12.

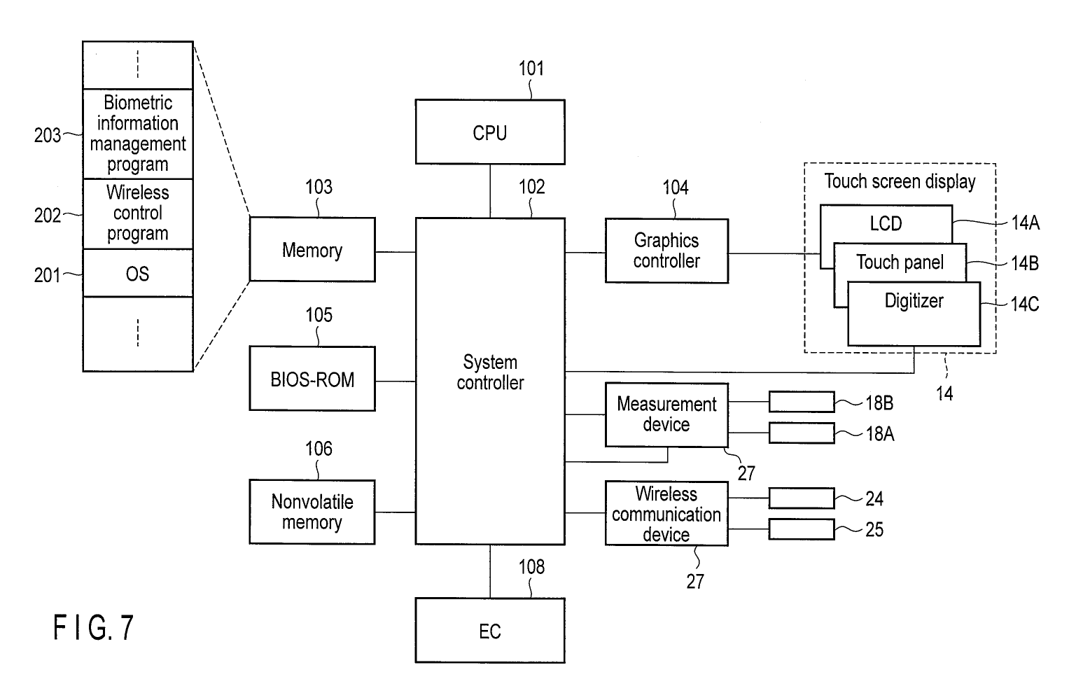

The housing 12 of the tablet computer 10 is shaped like a thin box, and its shape is substantially rectangular. In the touch screen display 14, a flat panel display including a liquid crystal display device (LCD 14A shown in FIG. 7), etc. and a sensor configured to detect a position designated by a pen or a finger on a screen of the flat panel display are incorporated. As the sensor, for example, an electrostatic capacity type touch panel, an electromagnetic induction type digitizer, etc. can be used. In the touch screen display 14 of the embodiment, two types of sensors, for example, a digitizer and a touch panel (touch panel 14B and digitizer 14C shown in FIG. 7), are incorporated.

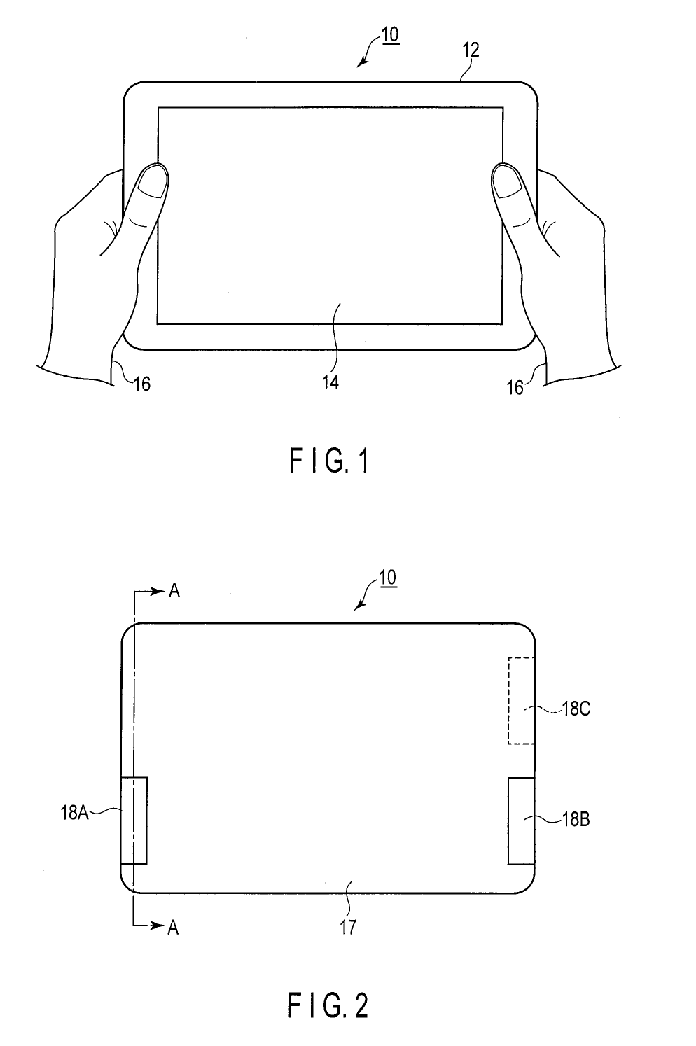

FIG. 2 is a plan view showing a back surface 17 of the tablet computer 10.

As shown in FIG. 2, on the back surface 17 of the tablet computer 10, two electrodes 18A and 18B for detecting the biometric information are provided. The electrodes 18A and 18B are capable of transmitting/receiving a weak electric signal. The electrodes 18A and 18B are formed in, for example, a rectangular shape and are arranged along short edges of the housing 12.

In addition, the electrodes 18A and 18B are arranged close to one of long edges. In other words, as shown in FIG. 1, the electrodes 18A and 18B are arranged at positions which the hands 16 may easily touch if the tablet computer 10 is held by the hands 16.

In an example of FIG. 2, the two electrodes 18A and 18B are arranged at respective short edges close to one of the long edges. However, for example, an electrode 18C and the electrode 18B may be arranged at one of the short edges. The electrode 18C may be arranged close to the other of the long edges instead of the electrode 18B.

The electrodes 18A and 18B are formed in the rectangular shape, but may also be formed in other shapes to which the user can easily touch fingertips, etc. The shapes and sizes of the electrodes 18A and 18B are determined in accordance with the type of biometric information to be detected such that a signal for detecting the biometric information can be input trough the electrodes 18A and 18B. Besides, in accordance with the type of the biometric information, it is also possible to provide only the electrode 18A. The biometric information includes, for example, electrocardiographic information (electrocardiographic signal waveform data) indicating a motion of heart, body fat information indicating a body fat percentage, body temperature information indicating a body temperature, etc. The other types of biometric information also may be detected.

In the example of FIG. 2, the electrodes 18A and 18B are provided on short edge sides of the housing 12, but may be provided on long edge sides.

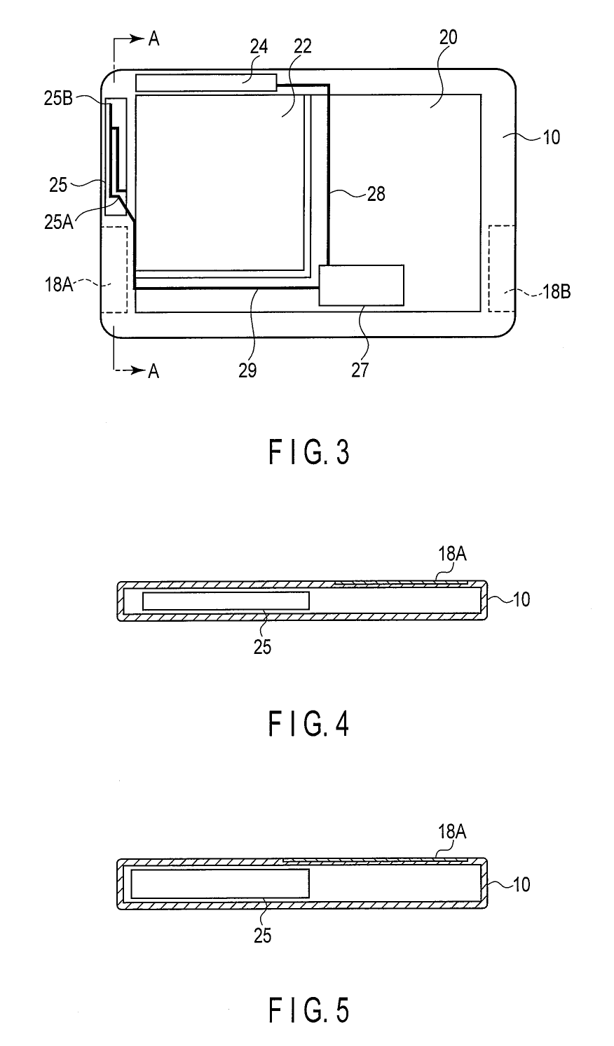

FIG. 3 shows an interior of the housing 12 seen from a back surface side of the tablet computer 10.

As shown in FIG. 3, in the interior of the housing 12, a main board 20, a battery 22, etc. are housed. The main board 20 is mounted with various electronic devices including a CPU, memory, a wireless communication device, etc. The battery 22 is formed in, for example, a rectangular shape and is housed such that a corner of the battery 22 is close to a corner of the housing 12 (an upper left corner in FIG. 3). To effectively use an interior space of the housing 12, the main board 20 is provided, for example, within a range excluding a space where the battery 22 is housed.

In the interior of the housing 12, two antennas 24 and 25 to be used for the wireless communication function are housed. The antennas 24 and 25 include, for example, antennas for WWAN (Wireless Wide Area Network), and are configured to transmit and receive radio waves for wireless communication such as 3G mobile communication of cell phones.

The antenna 24 is arranged, for example, along an upper edge of the housing 12 shown in FIG. 3, and the antenna 25 is arranged along a left edge of the housing 12 shown in FIG. 3. The antennas 24 and 25 are arranged in parallel with the respective edges of the housing 12, close to a corner formed by the upper edge and the left edge of the housing 12. Since the antenna 25 is arranged on the same edge as the electrode 18A, the antenna 25 may be arranged separately from the electrode 18A to reduce an influence of transmission and reception of the radio waves by the electrode 18A.

As shown in FIG. 3, the battery 22 is arranged close to a left corner of the housing 12, and the antennas 24 and 25 are arranged close to the left corner of the housing 12. In other words, by arranging the antennas 24 and 25 close to a position where the battery 22 is arranged, the antennas 24 and 25 are separated from the main board 20. Since the main board 20 is mounted with various electronic devices, a signal which can disturb wireless communication is emitted from the main board 20. By arranging the antennas 24 and 25 close to the battery 22 and separating the antennas 24 and 25 from the main board 20 as shown in FIG. 3, an influence of the signal (high frequency noise) emitted from the main board 20 can be reduced and the wireless sensitivities of the antennas 24 and 25 can be improved.

The antennas 24 and 25 are composed of, for example, wire element such as a monopole element, and thereby the antennas 24 and 25 are downsized. The antenna 24 is connected to a wireless communication device 27 mounted on the main board 20 via a feeder 28, and the antenna 25 is connected to the wireless communication device 27 via a feeder 29.

As shown in FIG. 3, a feeding point 25A of the antenna 25 is arranged to be located closer to the electrode 18A than to a center of the antenna 25 in the longitudinal direction. Since the electrode 18A and the antenna 25 are arranged in parallel along the left edge of the housing 12 as shown in FIG. 3, by arranging the feeding point 25A close to the electrode 18A, an end 25B (open end) of the monopole element is made opposite to a position where the electrode 18A is arranged.

Thus, for example, in a case where the user holds the tablet computer 10 with touching the hands 16 to the electrode 18A as shown in FIG. 1, even if the antenna 25 may be covered by the hands 16, only part of the antenna 25 on the feeding point 25A side may be covered. In other words, the end 25B (open end) of the monopole element cannot be easily covered by the hands 16. Thereby, it is possible to ensure good wireless communication quality by minimizing an influence of the user's hands 16 at the time of measuring the biometric information.

FIG. 4 shows an example of a side sectional view taken along an A-A line shown in FIG. 2. FIG. 4 shows a positional relationship between the electrode 18A and the antenna 25.

As shown in FIG. 4, the electrode 18A is provided on a back surface of the housing 12, and the antenna 25 is housed in the interior of the housing 12. If a length of an edge of the housing 12 where the electrode 18A and the antenna 25 are arranged is sufficiently long, the electrode 18A and the antenna 25 can be each arranged such that the electrode 18A and the antenna 25 do not overlap vertically as shown in FIG. 4. The electrode 18A has an influence on transmission and reception of radio waves by the antenna 25, and thus is preferably arranged as separately as possible.

On the other hand, if the size of the housing 12 is small, a place where the electrode 18A and the antenna 25 are arranged is restricted. Thus, there is a case where the electrode 18A and the antenna 25 are arranged such that the electrode 18A and the antenna 25 overlap vertically.

FIG. 5 shows an example of a side sectional view of the tablet computer 10 in a case where the size of the housing 12 is small. Even if the electrode 18A and the antenna 25 partly overlap vertically as shown in FIG. 5, an influence on transmission and reception of the radio waves due to overlap between the electrode 18A and the antenna 25 can be reduced by arranging the feeding point 25A of the antenna 25 at a position close to the electrode 18A as shown in FIG. 3. Similarly, even if the user touches the hands 16 to the electrode 18A and the hands 16 cover the antenna 25, part of the monopole element on the end (open end) side is not covered. Thus, a communication quality which allows stable wireless communication can be maintained.

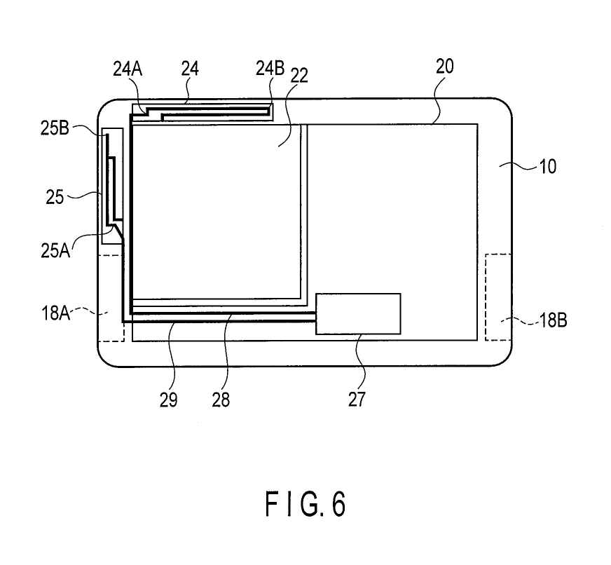

FIG. 6 is a diagram for explanation of arrangement relationship between the antenna 24 and the antenna 25.

FIG. 3 shows that the antennas 24 and 25 are arranged close to the left corner of the housing 12. FIG. 6 further shows arrangement of the monopole element of the antenna 24. In FIG. 6, a feeding point 24A of the antenna 24 is arranged on the left corner side of the housing 12. Since the antenna 24 is arranged along the upper edge of the housing 12, by arranging the feeding point 24A on the left corner side of the housing 12, an end 24B of the monopole element of the antenna 24 is located separately from the end 25B of the monopole element of the antenna 25. In other words, the feeding point 24A of the antenna 24 is arranged to be closer to the end 25B of the antenna 25 than to a center of the antenna 24 in the longitudinal direction. Thus, the end 24B of the monopole element of the antenna 24 is far from the end 25B of the monopole element of the antenna 25.

Thereby, as shown in FIG. 6, even if the antennas 24 and 25 are brought near the left corner of the housing 12, isolation between the antenna 24 and the antenna 25 is high. Thus, interference between the antennas can be reduced and performance of wireless communication can be improved.

The electrodes 18A and 18B are arranged on the back surface of the housing 12 in the configurations shown in FIGS. 1 to 6, but may also be arranged on a front surface or a side surface of the housing 12. Furthermore, an electrode having a shape covering the front surface, the side surface and the back surface of the housing 12 may be arranged. According to the embodiment, if the user holds the tablet computer 10 not in a special manner but in a natural manner as shown in FIG. 1, the electrodes 18A and 18B are provided on the front surface of the housing 12 which the hands 16 touch.

In the configuration of FIG. 3, the battery 22 has a rectangular shape and is arranged close to a corner of the housing 12. Thus, by arranging the antennas 24 and 25 at a position close to a position where the battery 22 is arranged, the antennas 24 and 25 are separated from the main board 20. Accordingly, if a shape of the battery 22 and a range where the battery 22 is housed in the housing 12 are different, arrangement of the antennas 24 and 25 can be determined in accordance with a position of the battery 22.

For example, if the battery 22 has a rectangular shape which stretches between the two short edges along a long edge of the housing 12, the battery 22 is housed close to one of the long edges of the housing 12 and the electrode 18A and the two antennas 24 and 25 are arranged in a line along the long edge close to which the battery 22 is housed.

If the electrode 18A is arranged close to a corner, the antenna 25, which is arranged adjacent to the electrode 18A, is arranged such that the feeding point 25A is located at a position close to the electrode 18A. The antenna 24 is arranged such that the feeding point 24A is located at a position close to the end 25B (electrode 18A side) of the antenna 25.

If the electrode 18A and the two antennas 24 and 25 are arranged in a line along the same long edge, the electrode 18A may be arranged between the antennas 24 and 25. In this case, the antennas 24 and 25 are arranged such that the respective feeding points 24A and 25A are located at a position close to the electrode 18A.

Thereby, the antennas 24 and 25 are arranged separately from the main board 20. Thus, the influence of the signal (high frequency noise) emitted from the main board 20 and the interference between the antenna 24 and the antenna 25 are reduced, and the wireless sensitivities can be improved.

In the above description, the antennas 24 and 25 are composed of the monopole element, but may be composed of, for example, a folded dipole element. If the folded dipole element is used, a folded portion corresponds to an end of the element, and the folded dipole element is arranged in a similar manner to the monopole element described above.

To stabilize detection of the biometric information using the electrodes 18A and 18B, the antenna 25 arranged close to the electrode 18A may be used mainly as an antenna for reception (sub-antenna), and the antenna 24 arranged farther than the antenna 25 may be used as an antenna for transmission and reception (main antenna). In other words, signals detected by the electrodes 18A and 18B cannot be easily affected by radio waves output from the antennas 24 and 25.

FIG. 7 shows a system configuration of the tablet computer 10 according to the embodiment.

As shown in FIG. 7, the tablet computer 10 comprises a CPU 101, a system controller 102, main memory 103, a graphics controller 104, BIOS-ROM 105, nonvolatile memory 106, the wireless communication device 27, and an embedded controller (EC) 108, a measurement device 109, etc.

The CPU 101 is a processor configured to control operations of various modules within the tablet computer 10. The CPU 101 is configured to execute various programs loaded to the main memory 103 from the nonvolatile memory 106, which is a storage device. These programs includes an operating system (OS) 201 and various application programs. The application programs includes a wireless control program 202, a biometric information management program 203, etc.

The wireless control program 202 controls transmission and reception of the radio waves for wireless communication output through the wireless communication device 27 from the antennas 24 and 25 under the control of the CPU 101. For example, the wireless control program 202 has a function of controlling output of the radio waves to be reduced in order to reduce an influence of radiation of the radio waves output from the antennas 24 and 25 on the human body, if it is detected that the human body is near the antennas 24 and 25. The biometric information management program 203 has a function of processing the biometric information detected by the measurement device 109.

The CPU 101 executes also a basic input and output system (BIOS) stored in the BIOS-ROM 105.

The system controller 102 is a device configured to connect a local bus of the CPU 101 with various components. A memory controller configured to perform access control over the main memory 103 is also built in the system controller 102. The system controller 102 has also a function of communicating with the graphics controller 104 via a serial bus, etc.

The graphics controller 104 is a display controller configured to control an LCD 14A used as a display monitor of the tablet computer 10. A display signal generated by the graphics controller 104 is transmitted to the LCD 14A. The LCD 14A is configured to display a picture image based on the display signal. On the LCD 14A, a touch panel 14B and a digitizer 14C are arranged. The touch panel 14B is an electrostatic capacity type pointing device for input on a screen of the LCD 14A. A touch position on the screen which a finger is touched to, a motion of the touch position, etc. are detected by the touch panel 14B. The digitizer 14C is an electromagnetic induction type pointing device for input on the screen of the LCD 14A. A touch position on the screen which a pen 100 is touched to, a motion of the touch position, etc. are detected by the digitizer 14C.

The wireless communication device 27 is a device configured to perform wireless communication such as 3G mobile communication and wireless LAN. The wireless communication device 27 is configured to transmit and receive the radio waves for wireless communication through the antennas 24 and 25, and has a function of controlling the strength of radio waves that are to be transmitted in accordance with the control of the CPU 101 (wireless control program 202).

The EC 108 is a one-chip microcomputer including an embedded controller for power management. The EC 108 has a function of turning the tablet computer 10 on and off in accordance with a user's operation on a power button.

The measurement device 109 is configured to detect the biometric information based on a signal input from at least one of the electrodes 18A and 18B. The measurement device 109 is configured to input a signal for detecting the biometric information using the electrodes 18A and 18B in accordance with the type, of biometric information to be detected. For example, the measurement device 109 uses the electrode 18B as an electrode for transmission of a weak electric signal, and the electrode 18A as an electrode for reception. The measurement device 109 is configured to carry out A/D conversion on an analog electric signal input through the electrode 18A (or the electrode 18B), and to generate data indicating the biometric information.

The measurement device 109 uses, for example, the electrode 18A for a proximity sensor configured to detect that the human body (hands 16, etc.) is near. The measurement device 109 can input an electric signal from the electrode 18A due to nearness, even if the human body does not touch the electrode 18A. The measurement device 109 outputs data generated based on a signal from the electrode 18A as data for detecting that the human body is near.

Next, an example of an operation of the tablet computer 10 according to the embodiment will be described.

In the tablet computer 10 according to the embodiment, for example, the biometric information detected through the electrodes 18A and 18B is transmitted to a data server connected via a network (not shown in the figures), and is managed in units of a user. In other words, the tablet computer 10 is configured to detect the biometric information using the electrodes 18A and 18B under the control of the biometric information management program 203, to connect with a base station, etc. via wireless communication, and to transmit the biometric information to the data server.

Thus, for example, as shown in FIG. 1, if the user holds the tablet computer 10 in the hands 16 and touches the electrodes 18A and 18B, the tablet computer 10 needs to transmit/receive the radio waves for wireless communication to/from the antennas 24 and 25.

If the user brings the hands 16 close to the electrode 18A to hold the tablet computer 10, the measurement device 109 generates and outputs data for the proximity sensor based on a signal input from the electrode 18A. If the data output from the measurement device 109 indicates a predetermined level, i.e., a level indicating that the human body (hands 16) is near the electrode 18A, the CPU 101 decreases the strength of the radio waves radiated from the antennas 24 and 25 by a function of the wireless control program 202.

If the measurement device 109 detects the biometric information based on a signal input from the electrodes 18A and 18B, the CPU 101 transmits the biometric information through the wireless communication device 27.

The antenna 25 is arranged near the electrode 18A. However, even if part of the electrode 18A is held by the hands 16, communication performance does not deteriorate, because the feeding point 25A of the antenna 25 is arranged at a position close to the electrode 18A as shown in FIG. 3 and FIG. 6.

Therefore, in the tablet computer 10 according to the embodiment, while the biometric information is detected using the electrodes 18A and 18B, good performance of wireless communication can be achieved. Thus, the biometric information can be transmitted to the data server without interruption of communication.

In the above description, the tablet computer 10 is implemented as, for example, a slate computer, but may be applied to, for example, a computer in which a first housing where a touch screen display (or a display) is housed and a second housing where a keyboard, etc. are housed are rotatably attached to each other by an attachment mechanism. In the computer, the first housing can be opened or closed with respect to the second housing. In the computer, for example, an antenna for wireless communication is arranged along an outer edge of the first housing, and an electrode for detecting the biometric information is arranged in the second housing. For example, if the first housing is closed with respect to the second housing such that the touch screen display provided in the first housing is exposed to the outside, the electrode and the antenna are arranged as shown in FIG. 6. If a battery and a main board are housed in the second housing, the battery and the antenna may be arranged in the same manner as shown in FIG. 6. Thereby, such an advantage as has been described regarding the tablet computer 10 can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus, comprising:
a first electrode configured to detect biometric information; and
a first antenna, wherein:
the first electrode and the first antenna are along an edge of a housing of the electronic apparatus; and
a feeding point of the first antenna is closer to the first electrode than to a center of the first antenna in a longitudinal direction.

2. The electronic apparatus of claim 1, wherein the first antenna is arranged such that an end of the first antenna is opposite to a position where the first electrode is arranged.

3. The electronic apparatus of claim 1, wherein a battery is in the housing close to a position where the first antenna is arranged.

4. The electronic apparatus of claim 1, further comprising a second antenna, wherein a feeding point of the second antenna is closer to an end of the first antenna than to a center of the second antenna in the longitudinal direction.

5. The electronic apparatus according to claim 4, wherein the first antenna is on a first edge of the housing and the second antenna is on a second edge which forms a corner with the first edge.

6. The electronic apparatus of claim 1, further comprising a controller configured to control a strength of a radio wave output from the first antenna based on a signal detected from the first electrode.

7. The electronic apparatus of claim 1, wherein a second electrode configured to detect the biometric information is on an edge different from the edge where the first electrode is arranged.
